(19) United States
(12) Patent Application Publication
(10) Pub. No.: US 2026/0058417 A1
(43) Pub. Date: Feb. 26, 2026

(54) CONNECTING ASSEMBLY FOR ELECTRICALLY CONNECTING A BUS SUBSCRIBER TO A DIFFERENTIAL BUS SYSTEM

(71) Applicant: ROSENBERGER HOCHFREQUENZTECHNIK GMBH & CO. KG, Fridolfing (DE)

(72) Inventors: Ralf Peteranderl, Alterrmarket (DE); Stephan Schreiner, Nussdorf (DE); Thomas Mueller, Berchtesgaden (DE)

(21) Appl. No.: 19/102,577

(22) PCT Filed: Feb. 23, 2023
(86) PCT No.: PCT/EP2023/054541

§ 371 Date: Feb. 10, 2025

(30) Foreign Application Priority Data
Aug. 12, 2022 (EP) 221902226.5

(51) Int. Cl. H01R 13/6588; H01R 4/242; H01R 13/504; H01R 13/6598; H01R 31/00

(52) U.S. Cl. CPC H01R 13/6588; H01R 4/242; H01R 13/5045; H01R 13/6598; H01R 31/005

(57) ABSTRACT

A connecting assembly for electrically connecting a bus subscriber to a differential bus system comprises a differential main conductor portion, which has a first electrical main conductor and a second electrical main conductor. The differential main conductor portion has a first sub-portion and a second sub-portion, which is electrically connected to the first sub-portion. A first terminal for electrically connecting to a first mating terminal of the bus subscriber is formed in the first electrical main conductor between the first sub-portion and the second sub-portion, and a second terminal for electrically connecting to a second mating terminal of the bus subscriber is formed in the second electrical main conductor between the first sub-portion and the second sub-portion. The first and second electrical main conductors are surrounded, at least in the first sub-portion or in the second sub-portion, by one body in each case, said body being made of magnetizable material.

### FIELD OF THE INVENTION

The present application assumes the priority of European patent application n° 22 190 226.5, the content of which, by reference, is included herein in its entirety.

The present invention relates to a connecting assembly for electrically connecting a bus subscriber to a differential bus system, having the features as disclosed herein.

### TECHNICAL CONTEXT

Differential bus systems are employed in numerous fields of application, for example in industry, in the automobile sector or in offices, for data transmission between multiple bus subscribers. The conductor system of a differential bus system essentially comprises a differential main conductor, from which a respective differential spur branches off to each bus subscriber. Alternatively, the bus subscriber can also be directly connected to the differential main conductor, without the interposition of a differential spur. Both shielded and unshielded conductors are employed.

FIG. 1A illustrates an equivalent circuit layout of a differential bus system. The transmission characteristic of the differential bus system proceeds not only from the ohmic linear electric constants R_{H} and G_{H}, the capacitive linear electric constants C_{H} and the inductive linear electric constants L_{H} of the individual conductor sections, but also from the input impedance of each bus subscriber TN. The input impedance of a bus subscriber TN, i.e. of an electronic assembly, proceeds from an equivalent circuit layout comprised of an ohmic input resistance R_{dev}, a stray capacitance C_{dev} and a stray inductance L_{dev} on the differential input of the bus subscriber TN. In the equivalent circuit layout according to FIG. 1A, the bus subscriber TN represented in the left-hand half is directly connected to the main conductor of the bus system, whereas the bus subscriber TN represented in the right-hand half is connected to the main conductor of the bus system via a spur having the ohmic linear line constant R_{S} and G_{S}, the capacitive linear line constant C_{S} and the inductive linear line constant L_{S}.

In particular, the stray capacitance C_{dev} on the differential input of an electronic assembly, which results from the stray properties of actual components of the electronic assembly in relation to the technical properties of the associated ideal component, significantly distorts the characteristic wave impedance of the differential bus. The stray capacitance C_{dev}, for the improvement of the transmission properties of the bus system according to FIG. 1B, can be offset by an additional inductance L_{C} in the two main conductors of the differential bus system. To this end, customarily, corresponding conductor sections of the differential conductor system are interrupted and, in each case, a discrete inductive component, preferably a discrete coil, is incorporated therein and connected by means of soldering to the respectively adjoining conductor sections.

The soldering process is a comparatively complex, and thus expensive production method. The risk of poor soldered joints, i.e. of “cold solder joints”, should not be underestimated, and can result in an additional increase in production costs associated with reworking.

This is a situation which requires improvement.

US 2019/0109417 A₁ discloses a plug connector having a housing which can be fitted to a matching housing of a mating plug connector, having multiple terminals, which are retained by the housing and are mutually electrically connected, and having a noise reduction element, which is retained in the housing, in order to reduce noise generated in the terminals. The noise reduction element is arranged on at least one of the terminals, and is not arranged on at least one of the remaining terminals of the multiple terminal. The noise reduction element is produced of a material which contains a ferrite.

### SUMMARY OF THE INVENTION

In this context, the fundamental object of the present invention is the disclosure of a technical compensating facility in a differential bus system for a stray capacitance which is present on a differential input of a bus subscriber, which facility can be produced using cost-effective production technology and improves the high-frequency transmission behavior of the differential bus system.

According to the invention, this object is fulfilled by a connecting assembly for electrically connecting a bus subscriber to a differential bus system, having the disclosed herein.

The following is provided accordingly:

A connecting assembly for electrically connecting a bus subscriber to a differential bus system, comprising
a differential main conductor section
having a first main electrical conductor and
a second main electrical conductor,
wherein the differential main conductor comprises a first sub-section and
a second sub-section which is electrically connected to the first sub-section,
wherein, in the first main electrical conductor, between the first sub-section and the second sub-section, a first terminal for electrically connecting to a first mating terminal of the bus subscriber, and
in the second main electrical conductor, between the first sub-section and the second sub-section, a second terminal for electrically connecting to a second mating terminal of the bus subscriber are configured,
in the second main electrical conductor, between the first sub-section and the second sub-section, a second terminal is configured for electrically connecting to a second mating terminal of the bus subscriber,
wherein the connecting assembly comprises a first electrical spur conductor and a second electrical spur conductor, wherein the first electrical spur conductor is connected to the first terminal, and is designed to be connectable to the first mating terminal, and the second electrical spur conductor is connected to the second terminal, and is designed to be connectable to the second mating terminal, and
wherein only the first and the second main electrical conductor, at least in the first sub-section or in the second sub-section, is respectively enclosed by a body of a magnetizable material.

Preferably, in particular, neither of the two terminals is enclosed by a further body of a magnetizable material. Consequently, for example, the spurs are preferably not enclosed by a further body of a magnetizable material.

According to the fundamental concept of the present invention, in place of a discrete inductive component in a specific conductor section of a differential bus system, the conductor section is enclosed by a body of a magnetizable material. The inductive linear electric constant of the conductor section can be increased by the enclosure thereof in a body of a magnetizable material. In particular, the increase in the inductance of the conductor section can be adjusted, in a targeted manner, by means of an appropriate geometry and an appropriate material selection for the body of a magnetizable material. Thus, advantageously, the stray capacitance on the differential input of the bus subscriber can be compensated by the body of a magnetizable material.

Additionally, in place of an interruption of the conductor section, an insertion of the discrete inductive component into the interrupted conductor section and a connection of the discrete inductive component to the interrupted conductor section by means of soldering, only a simple assembly process is required, wherein the body of a magnetizable material is introduced over the conductor section.

For a particularly advantageous compensation of the stray capacitance on the differential input of the bus subscriber, bodies of the magnetizable material are preferably introduced over the conductor sections of the differential bus system which are closest to the respective bus subscriber.

A bus system is an arrangement of conductors employed in common by multiple bus subscribers, who are connected to the bus system, for the purposes of data transmission. The conductor arrangement is generally comprised of a main line (trunk line) and a plurality of spurs (stub lines) which branch off from the main line and are respectively connected to an associated bus subscriber. A direct connection of bus subscribers to the main line is also conceivable. The main line preferably assumes a linear structure. In a linear structure, both ends of the main line can be respectively connected to an appropriate impedance, in order to prevent any unwanted reflections of a high-frequency signal which is transmitted via the bus system. In addition to a linear structure, however, other structures of a main line are also conceivable, for example an annular structure or a “tree” structure.

In the interests of interference immunity, in particular during the transmission of a high-frequency signal, state-of-the-art transmission systems, for example USB, Ethernet, HDMI, SATA, etc., are differentially configured. They assume a differential conductor arrangement, in which a differential signal is transmitted. A differential conductor arrangement thus comprises a main line having a first main electrical conductor and a second main electrical conductor and, optionally, a plurality of spurs having a respective first electrical spur conductor and a respective second electrical spur conductor.

In this context, it should be observed that the terms “first main electrical conductor”, “second main electrical conductor” and “differential main conductor section”, in the present case and hereinafter, in particular, can be understood as the electrical conductors (e.g. Litz wires) of a differential main line, i.e. of two cables of a differential bus systems, or as the electric current paths in two contact elements of a differential electrical connector, in particular of a differential electric bus plug connector, which is arranged between two conductor section of a differential main line of a differential bus system.

In an equivalent manner, the terms “first electrical spur”, “second electrical spur” and “differential spur section”, in the present case and hereinafter, in particular, are to be understood as the electrical conductors (e.g. Litz wires) of a differential spur conductor of a differential bus system between the main line and the bus subscriber, or as the electric current paths in two contact elements of an electrical connector, in particular of a differential electric bus plug connector, which are arranged in the spur path between the main line path and the bus subscriber of a differential bus system.

The connecting assembly comprises at least one differential main conductor section, in which a first and a second terminal are configured which are respectively electrically connectable to a first or a second mating terminal of a bus subscriber. The first and the second mating terminal of the bus subscriber form the differential terminal or the differential input of the bus subscriber. The first and the second terminal are configured between a first sub-section and a second sub-section of the differential main conductor section. Between the first and the second sub-section, the first terminal in the first main electrical conductor and the second terminal in the second main electrical conductor are respectively configured. The connecting assembly, having the two sub-sections of the differential main conductor section and the electrical connection to the bus subscriber, thus comprises a differential T-shaped structure. This differential T-shaped structure can either be embodied in the form of a T-shaped differential line section, or in the form of a T-shaped differential plug connector.

A connecting assembly of this type is preferably electrically connected to two equivalent connecting assemblies, each of which is electrically connected to the nearest adjoining bus subscribers in the bus system.

The respective electrical connection between two adjoining connecting assemblies, in the event of a short distance, can be executed directly or, in the event of a longer distance, via a correspondingly dimensioned differential main conductor section which is arranged therebetween. If the respective bus subscriber is located at one end of the main line, the associated connecting assembly is alternatively terminated at the associated differential main conductor section with an appropriate impedance or with a bus subscriber, at the differential input of which, in addition to stray equivalent elements, an appropriate impedance is applied.

The first main electrical conductor and the second main electrical conductor of the differential main conductor section can preferably be routed in a mutually parallel arrangement. This applies particularly to a respective manifestation of the first and second main conductors in the form of a contact element in the main conductor path of a differential electric bus (plug) connector. In the event of a respective manifestation of the first and second main conductors in the form of Litz wires of a main electrical line, i.e. in the form of Litz wires of a cable which forms a main electrical line, the two main electrical lines of the differential main conductor pair, and thus the first and the second main electrical conductors, can also be routed in a mutually laid-up arrangement. In this context, it should be observed that the two main lines of a differential bus system can be configured both as separate lines and, preferably, also as a single line which is comprised of two cables.

In a first manifestation of a connecting assembly, the first and the second can respectively be immediately, i.e. directly electrically connected to the associated mating terminals of the bus subscriber.

Preferably, the first terminal and the second terminal can respectively be a plug-in interface of a differential bus plug connector. This can be, for example, a contact-connection region of a contact element of a differential bus plug connector, which is electrically contact-connected to an associated mating contact element of a mating plug connector which is embodied at a differential input of a bus subscriber, preferably in the form of a domestic plug connector. Alternatively, this can also be an insulation-piercing connecting device, which is electrically contact-connected to a main conductor on one side and, at the other, comprises a contact-connection region which is contact-connected to a mating contact of a mating plug connector which is configured in the bus subscriber.

In a second manifestation of a connecting assembly, the first and the second terminal can respectively be electrically connected to a first electrical spur conductor and a second electrical spur conductor of a differential spur conductor section, which is configured within the connecting assembly. The first and the second electrical spur conductor can be respectively configured as a contact element or respectively configured as a contact section of a contact element in a differential bus plug connector. The contact elements of the differential bus plug connector can be respectively contact-connected to the associated mating contact elements of a mating plug connector of the bus subscriber. It is also conceivable that the first electrical spur conductor and the second electrical spur conductor respectively are Litz wires of a differential spur, the ends of which are electrically connected to a plug connector for the purposes of electrical connection with an associated mating plug connector of the bus subscriber. The spur conductor can also be an insulation-piercing connecting device which is electrically contact-connected to the main conductor on one side and, at the other, comprises a contact-connection region which enables a contact-connection with the mating contact element of a mating plug connector which is configured in the bus subscriber.

The first electrical spur conductor and the second electrical spur conductor of the differential spur conductor section can also be preferably routed in a mutually parallel arrangement.

Alternatively, the first electrical spur conductor and the second electrical spur conductor of the differential spur conductor section can also be routed in a mutually laid-up arrangement, in the event that the first and the second spur conductors are respectively configured as Litz wires of an electrical spur.

According to the invention, the first and the second main electrical conductors, both in the first sub-section and in the second sub-section of the differential main conductor section, can be respectively enclosed by a body of a magnetizable material.

An embodiment of this type enables an optimum compensation of the influence of the stray capacitance which is applied at the differential input of the bus subscriber upon the transmission behavior of the differential bus system. Alternatively, it is also possible that either the first and the second main electrical conductors, in the first sub-section of the differential main conductor section, or the first and the second main electrical conductors, in the second sub-section of the differential main conductor section, are respectively enclosed by a body of a magnetizable material.

In both cases, the first main electrical conductor and the second main electrical conductor are mutually mechanically separated by the body of a magnetizable material such that, in the event of a current flux in the first and second main electrical conductor, in each case, a different magnetic flux path can be formed in the at least one body, such that the inductance, both in the first main electrical conductor and in the second main electrical conductor, is increased and will require adjustment accordingly.

Magnetizable materials can preferably be ferromagnetic metal alloys, or ferromagnetic materials in the form of “ferrites”. Essentially, magnetizable materials having a low residual magnetism are employable as a precondition for a low-loss magnetic reversal at high-frequency currents, and in the interests of low eddy currents. In particular, bodies of a ferrite material, or “ferrite cores”, assume these material properties.

The adjustment of inductance in the first and second main conductors in the first and second sub-section of the differential main conductor section by means of the respective enclosing body of the magnetizable material is executed by means of the “A_{L} value” of the magnetizable body, which corresponds to the inverse value of the magnetic resistance Rm of the magnetizable body which, in turn, is dependent upon the geometry and the material of the body. Primarily, the inductance can be increased, and thus adjusted, by means of a material having a high relative permeability μᵣ and a body having a large axial length.

The individual body of a magnetizable material is preferably embodied in the form of a body which is separable from the respective main electrical conductor, i.e. in the form of a body which is axially displaceable on the respective main electrical conductor is linearly moveable from the respective main electrical conductor. Alternatively, the individual body of a magnetizable material can also be embodied as a coating of the respective main electrical conductor, having a magnetizable coating material. In the latter case, the body of a magnetizable material is materially bonded to the respective main electrical conductor. Finally, the body of a magnetizable material can also be formed as an encapsulation of the individual electrical conductor.

Advantageous configurations and further developments proceed from the further description, in consideration of the figures in the drawing.

It is understood that the above-mentioned features, and those described hereinafter, are not only employable in the respectively indicated combination, but also in other combinations, or in isolation, without departing from the scope of the present invention.

In a first manifestation of a body of a magnetizable material, the body is configured as a bushing. Each main electrical conductor, at least in a first sub-section or in a second sub-section, is respectively enclosed by an associated bushing body of a magnetizable material in which, in the event of a current flux, an associated magnetic flux path can be formed.

In a second manifestation of a body of a magnetizable material, the body comprises two penetrations in its longitudinal axis, and is thus configured in the form of a double-aperture body or a double-aperture core. The first main electrical conductor is led through one aperture, and the second main electrical conductor is led through the other aperture. In the web region of the double-aperture body, between the first and second main electrical conductors, on the grounds of the differential signal, the two magnetic fluxes of the first and second main electrical conductors are structurally superimposed.

Preferably, the cross-section of the magnetizable body in the first manifestation assumes a circular outer profile and, in the second manifestation assumes an elliptical or oval outer profile. However, a rectangular outer profile, in particular a quadratic outer profile, or a polygonal outer profile is also conceivable. The inner profile of the magnetizable body is geometrically and dimensionally adapted to the first or second main electrical conductor.

The connecting assembly preferably comprises a housing, in which at least the differential main conductor section is arranged. In the housing, three penetrations can preferably be provided through which, respectively, the first sub-section and the second sub-section of the differential main conductor section, and the electrical connection to the bus subscriber are led.

In the interests of simple assembly, the housing is preferably of a multi-part design comprised of multiple housing shells, in particular a two-part design comprised of two housing shells.

The housing is employed for guiding the individual conductors, i.e. the first and the second main conductor and, optionally, the first and the second spur conductors. Additionally, the housing seals the contacts vis-á-vis humidity and contamination from the exterior. Finally, the housing can also secure the individual magnetizable bodies, which are displaceable on the individual electrical conductors, for example by means of strut-shaped moldings in the housing shells, in a specific axial position relative to the individual electrical conductors. A materially bonded radial fixing can be executed, for example, by means of adhesive bonding, or a friction-locked radial fixing can be executed by the press-fitting of magnetizable bodies in the housing.

The housing can preferably be formed of an electrically insulating material. For the embodiment of a shielded bus system, the housing can also be of metallic construction, or can comprise a metallic coating. In an electrically insulating housing, metal shielding plates can also be arranged in which, at the individual plug-in interfaces, external conductor contact elements of the differential bus plug connector are formed in each case.

In a further preferred manifestation of a magnetizable body, the magnetizable body is configured with a multi-part design. The magnetizable body is thus comprised of multiple sub-bodies, in particular of two sub-bodies, each of which extends over a different angular segment relative to a longitudinal axis of the magnetizable body. The individual sub-bodies are respectively fixed in an associated housing part or an associated housing shell of the housing.

A technical advantage of a manifestation of a magnetizable body of this type is provided, in that it is not necessary for the individual magnetizable bodies to be “threaded” over the individual electrical conductors, which magnetizable bodies can be introduced beforehand into the associated housing shells and secured therein. A retrofitting of a differential bus system with magnetizable bodies is thus enabled in a simple manner, with no interruption of the differential bus conductor system, simply by a replacement of the housing. A multi-part solution of this type for a magnetizable body is achievable for both the bushing variant and the double-aperture variant of the body. In order to prevent any gaps between the sub-bodies which might reduce inductance, thereby resulting in a defective compensation, a high-precision manufacture and assembly of individual parts must be observed.

In the interests of improved precision, in place of individual sub-bodies which are secured in associated housing shells, in a further preferred manifestation, correspondingly formed regions of the housing shell are coated with a magnetizable material.

If the first main electrical conductor and the second main electrical conductor respectively, both in the first sub-section and in the second sub-section of the differential main conductor section, are respectively enclosed by a magnetizable body, in a further manifestation of a magnetizable body for the first and the second main electrical conductor respectively, the magnetizable bodies in the first and second sub-section of the differential main conductor section can be combined is a single magnetizable body. This manifestation can be employed, in a particularly advantageous manner, for those variants in which the magnetizable body is embodied by a coating of the housing shells with a magnetizable coating material.

This manifestation can also be easily implemented for a first or second main conductor which is respectively configured as a contact element and in which, in each case, a contact socket is configured by way of the first or second terminal for electrical connection to a bus subscriber. In this case, in the common magnetizable body, only a single through-hole for the feedthrough of the electrical connection to the bus subscriber is required.

In a first embodiment of a connecting assembly, a first edge of a first insulation-piercing connecting device is electrically connected to the first terminal of the first main electrical conductor. In an equivalent manner, a second edge of a second insulation-piercing connecting device is electrically connected to the second terminal of the second main electrical conductor.

The first edge of the first insulation-piercing connecting device and the second edge of the second insulation-piercing connecting device thus penetrate the insulation of the first main conductor and of the second main conductor, and thus contact-connect the first main electrical conductor at a first terminal, or the second main electrical conductor at a second terminal.

Conventional LSA insulation-piercing connection technology (with no soldering, screwing or insulation stripping) can be deployed in the interests of an intended simplification of production.

The first insulation-piercing connecting device moreover comprises a first contact terminal, which is preferably integrally connected to the first edge and is designed to be electrically connectable to a first mating terminal of a bus subscriber. In an equivalent manner, the second insulation-piercing connecting device comprises a second contact terminal, which is preferably integrally connected to the second edge and is designed to be electrically connectable to a second mating terminal of a bus subscriber. The first and second contact terminal of the first insulation-piercing connecting device or of the second insulation-piercing connecting device respectively constitute contact elements of a differential plug-in interface, which respectively contact-connect mating contact elements of a mating plug connector of the bus subscriber. Alternatively, the contact elements of the differential plug-in interface can also contact-connect mating contact elements of a mating plug connector, which is electrically connected to a differential spur conductor which, in turn, by means of a plug-in electrical connection, is connectable to the bus subscriber. Finally, in a further variant, the first and second contact terminal of the first insulation-piercing connecting device or of the second insulation-piercing connecting device can be respectively electrically connected to insulation-stripped spurs, i.e. to a first electrical spur conductor or to a second electrical spur conductor, preferably by means of a crimped connection or a plug-in terminal connection. A differential spur of this type, in turn, is electrically connectable to the bus subscriber by means of an electrical plug-in connection. In particular, this last variant represents the simplest embodiment, with respect to production technology, of a connecting assembly between the main line and the respective bus subscriber of a differential bus system which is embodied in the form of a T-junction.

In the first embodiment of a connecting assembly according to the invention by means of insulation-piercing connection technology, magnetizable bushing bodies preferably respectively enclose the first main line section and the second main line section, at least in a first sub-section or in a second sub-section.

In a second embodiment of a connecting assembly, the connecting assembly according to the invention is embodied as a differential bus plug connector of the differential bus system. The first main electrical conductor of the differential main conductor section of the connecting assembly is configured as a first contact element of the differential bus plug connector. In an equivalent manner, the second main electrical conductor of the differential main conductor section is configured as a second contact element of the differential bus plug connector.

In a preferred manifestation of the second embodiment, the differential bus plug connector comprises a first and a second three-arm contact element. The first and second main electrical conductor, in the first sub-section of the differential main conductor section of the connecting assembly respectively form a first contact arm of the first or second three-arm contact element. The first and second main electrical conductors, in the second sub-section of the differential main conductor section of the connecting assembly, respectively form a second contact arm of the first or second three-arm contact element, and the first and second electrical spur conductors of the connecting assembly respectively form a third contact arm of the first or second three-arm contact element. The first and second three-arm contact elements can be respectively configured with a T-shaped, F-shaped or Y-shaped design. The first and second three-arm contact elements can respectively configured with a one-part or multi-part, for example a two-part construction. In the case of a multi-part embodiment, the individual contact arms of the first or second three-arm contact element can be mutually connected, for example by means of a screw connection or a press-fit connection.

### Contact-connection Between the Differential Bus Plug Connector

and the associated differential mating plug connectors is executed in accordance with conventional contact-connection technologies associated with plug connector engineering, i.e. preferably by means of a radial contact-connection or, alternatively, by means of an end-face contact connection.

The first and second contact element respectively, at least in a first sub-section or in a second sub-section, are enclosed by a magnetizable body. In the case of three-arm contact elements, at least the first contact arm or the second contact arm of the first and second three-arm contact element are respectively enclosed by a magnetizable body. At the axial ends of the first and second contact elements respectively, contact-connection with mating contact elements of associated mating plug connectors is executed.

In the context of a unified overall inventive concept, the invention also encompasses a differential bus plug connector, the connecting assembly of which in turn comprises a first terminal and a second terminal, wherein the first terminal and the second terminal are respectively configured in the form of a contact-connection region for a mating contact element of a mating plug connector of the bus subscriber, preferably in the form of blind holes or socket contacts.

In addition to three-arm contact elements, linear contact elements are also conceivable, wherein contact-connection with mating plug connectors is executed at the axial ends and in a central region, preferably in the center, of the contact element.

The first and second main electrical conductor of the first sub-section of the connecting assembly respectively form a contact element section from one axial end to the central region, preferably to the center, of the respective linear contact element. The first and second main electrical conductor of the second sub-section of the connecting assembly respectively form a contact element section from the central region, preferably from the center, to the other axial end of the respective linear contact element. The differential spur conductor section having the first electrical spur conductor and the second electrical spur conductor, in this case, is realized externally to the bus plug connector. The differential spur conductor section is comprised of the mating contact elements of the differential mating plug connector which respectively contact-connect the two linear contact elements of the differential bus plug connector in the central region, preferably in the center, and the spur conductors which are respectively connected to the mating contact elements, and which respectively lead to the bus subscriber.

For the contact-connection of the linear contact elements of the differential bus plug connector with the associated mating contact elements of the differential mating plug connector, blind holes are preferably configured in a central region of the contact elements, preferably in the center thereof, into which the pin-shaped mating contact elements can be introduced.

At least the contact element section between one axial end and the central region, preferably the center, of the two linear contact elements or the contact element section between the center and the other axial end of the two linear contact elements are respectively enclosed by a magnetizable body.

The first and second contact element can be respectively produced by a machining method (turning, milling) or by a stamping and bending technique.

The invention, in addition to the differential bus plug connectors which comprise the connecting assembly according to the inventions, also encompasses a differential plug connector assembly of a differential bus plug connector and at least one differential mating plug connector, which can be respectively plugged into one of the three plug-in connector interfaces of the differential bus plug connector, together with the differential bus plug connector. Respective technical features of connecting assembly and the differential bus plug connector disclosed heretofore and hereinafter also apply, in an analogous manner, to the differential plug-in connector assembly.

In a further preferred manifestation of a differential plug connector assembly, it is possible for the magnetizable bodies not to be arranged within the differential bus plug connector, but to be routed above the mating contact elements of at least one differential mating plug connector which is connected to the first sub-section or to the second sub-section of the differential main conductor section of the differential bus plug connector.

Again, in this case, the first and second main electrical conductor of the connecting assembly are respectively enclosed by a magnetizable body. Technical features of the connecting assembly and of the differential bus plug connector disclosed heretofore and hereinafter also apply, in an analogous manner, to the differential mating plug connector.

Finally, it should be observed that the individual magnetizable bodies can also be arranged externally to the housing of a differential bus plug connector, externally to the housing of a differential electrical connector which is configured with insulation-piercing connecting device, or externally to the differential plug connector assembly, in each case above the first and second main electrical conductor.

The above-mentioned configurations and further developments can be mutually combined in an arbitrary manner, insofar as this is appropriate. Further possible configurations, further developments and implementations of the invention also include combinations of the above-mentioned features of the invention, or of those which are described hereinafter with reference to exemplary embodiments, which are not explicitly indicated. In particular, a person skilled in the art will also incorporate individual aspects by way of improvements or additions to the respective basic form of the present invention.

### DESCRIPTION OF CONTENTS OF THE DRAWING

The present invention is described in greater detail hereinafter with reference to exemplary embodiments which are disclosed in the figures of the drawing. In the drawing:

FIG. 1A shows a representation of circuit layout for a differential bus system according to the prior art;

FIG. 1B shows a representation of a circuit layout for a differential bus system having stray capacitance compensation, according to the prior art;

FIG. 2A shows an isometric representation of a connecting assembly according to the invention, having a first manifestation of magnetizable bodies;

FIG. 2B shows an isometric representation of a connecting assembly according to the invention, having a second manifestation of magnetizable bodies;

FIG. 3A shows an exploded representation of a connecting assembly according to the invention, which is embodied as a differential bus plug connector;

FIG. 3B shows a sectional representation of a connecting assembly according to the invention, which is embodied as a differential bus plug connector;

FIG. 4A shows an exploded representation of a connecting assembly according to the invention, which is embodied as a differential bus plug connector, having multi-part magnetizable bodies;

FIG. 4B shows a sectional representation of a connecting assembly according to the invention, which is embodied as a differential bus plug connector, having multi-part magnetizable bodies;

FIG. 5A shows a sectional representation of a connecting assembly according to the invention, which is embodied by means of insulation-piercing connecting devices;

FIG. 5B shows an exploded representation of a connecting assembly according to the invention, which is embodied by means of insulation-piercing connecting devices, in a disassembled state; FIG. 5C shows an exploded representation of a connecting assembly according to the invention, which is embodied by means of insulation-piercing connecting devices, in a semi-assembled state;

FIG. 6A shows an exploded representation of a plug connector assembly according to the invention, in a semi-assembled state; and FIG. 6B shows a sectional representation of a plug connector assembly according to the invention.

The attached figures in the drawing are intended to communicate a further understanding of embodiments of the invention. They illustrate embodiments and, in conjunction with the description, are employed for the clarification of principles and concepts of the invention. Further embodiments and many of the above-mentioned advantages are inferred in consideration of the drawings. Elements in the drawings are not necessarily shown in a mutually true-to-scale representation.

In the figures of the drawing, identical, functionally equivalent and identically functioning elements, features and components—unless indicated otherwise—are respectively identified by the same reference symbols.

Hereinafter, the figures are described in a concerted and comprehensive manner.

### DESCRIPTION OF EXEMPLARY EMBODIMENTS

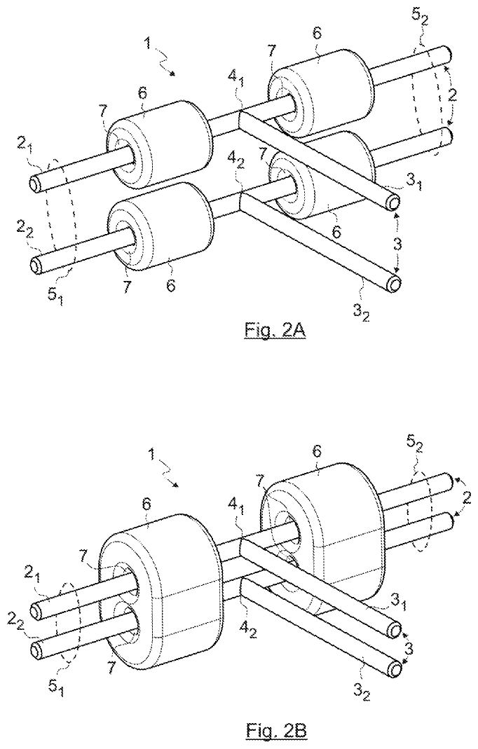

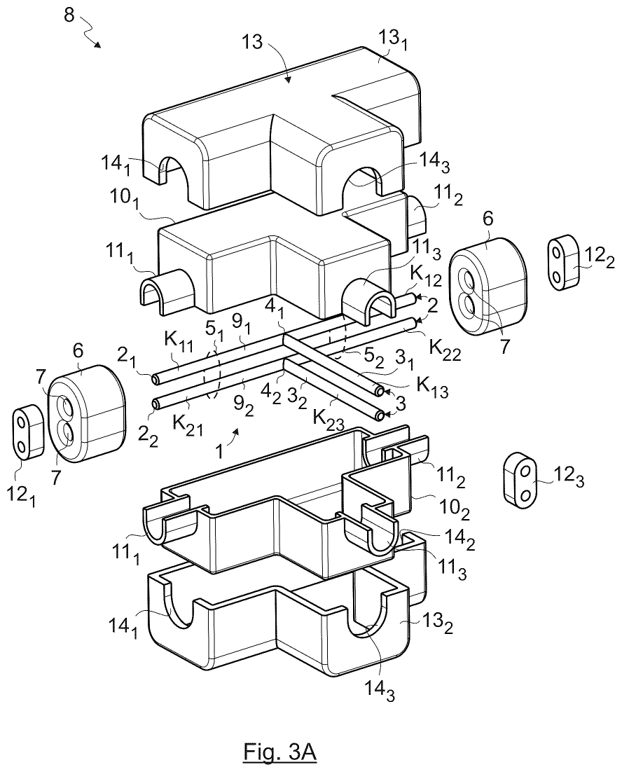

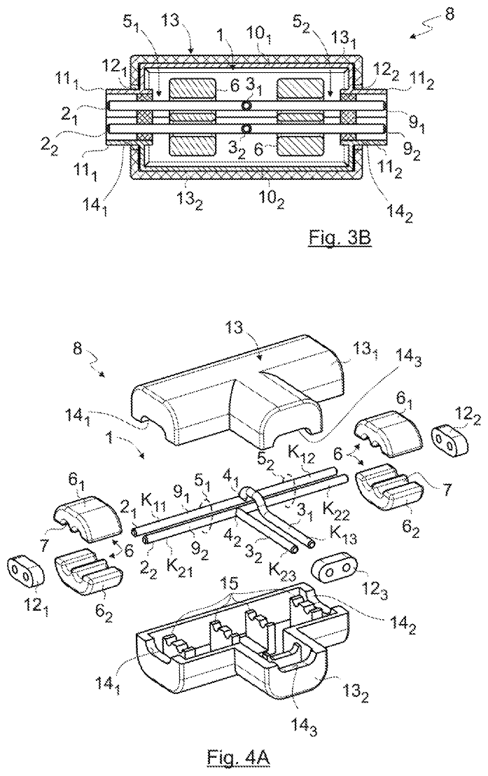

In FIGS. 2A and 2B, a connecting assembly 1 for a differential bus system is respectively represented. The connecting assembly 1 is comprised of a differential main conductor section 2 and a differential spur conductor section 3. The differential main conductor section 2, in turn, is comprised of a first main conductor 21 and a second main conductor 2₂. The differential spur conductor section 3, in turn, is comprised of a first spur conductor 3₁ and a second spur conductor 3₂. The first spur conductor 3₁ is connected to the first main conductor 2₁ at a first terminal 4₁ of the first main conductor 2₁ between a first sub-section 5₁ and a second sub-section 5₂ of the differential main conductor section 2. In an equivalent manner, the second spur conductor 3₂ is connected to the second main conductor 2₂ at a second terminal 4₂ of the second main conductor 2₂ between the first sub-section 5₁ and the second sub-section 5₂ of the differential main conductor section 2.

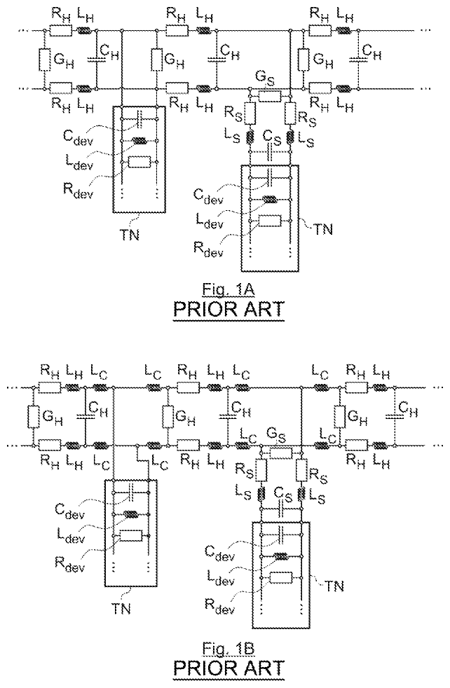

The differential spur conductor section 3 is connected either directly or indirectly, via a further differential line section, to a differential input of an electrical assembly which is assigned to a bus subscriber TN (c.f. FIGS. 1A and 2A) of the differential bus system. The first sub-section 5₁ and the second sub-section 5₂ of the differential main conductor section 2 are respectively electrically connected by means of further connecting assemblies to further bus subscribers TN of the differential bus system or, alternatively, are terminated by an appropriate impedance.

The first main conductor 2₁ and the second main conductor 2₂, according to FIG. 2_{A}, in the first sub-section 5₁ and in the second sub-section 5₂ of the differential main conductor section 2, are respectively enclosed by a body 6 of a magnetizable material. The body 6 is preferably produced from a ferrite material. In the representation according to FIG. 2A, the magnetizable body 6 is configured in the form of a bushing, and respectively encloses only a single main conductor 2₁ or 2₂. Moreover, the first main conductor 2₁ and the second main conductor 2₂ in FIG. 2A, in the first sub-section 5₁ and in the second sub-section 5₂ respectively, are respectively enclosed by a magnetizable bushing body 6. A variant is also conceivable, in which the first main conductor 2₁ and the second main conductor 2₂ respectively are enclosed by a magnetizable body 6 only in the first sub-section 5₁ or only in the second sub-section 5₂.

FIG. 2B illustrates a second manifestation of a magnetizable body 6, which respectively encloses the first main conductor 2₁ and the second main conductor 2₂ in combination. To this end, the magnetizable body 6 comprises two axial penetrations 7, through which the first main conductor 2₁ and the second main conductor 2₂ are led.

FIGS. 3A and 3B illustrate an embodiment of a connecting assembly 1 for a differential bus system, which is configured as a differential bus plug connector 8. To this end, the differential bus plug connector 8 comprises a first contact element 9₁ and a second contact element 9₂, which are respectively configured with three arms and are respectively employed as an inner conductor contact element. The axial ends of the three contact arms of the first and the second contact elements 9₁ and 9₂ respectively form a contact-connection region K₁₁, K₂₁, K₁₂, K₂₂, K₃₁ and K₃₂ for electrical contact-connection to an associated mating contact element of a differential mating plug connector.

The contact arms of the first and second contact elements 9₁ and 9₂, which are situated in the differential main conductor section 2 between the contact connection region K₁₁ or K₂₁ and the first terminal 4₁ or the second terminal 4₂, respectively form the first main conductor 2₁ and the second main conductor 2₂ in the first sub-section 5₁ of the connecting assembly 1. The contact arms of the first and second contact elements 9₁ and 9₂, which are situated in the differential main conductor section 2 between the contact-connection region K₁₂ or K₂₂ and the first terminal 4₁ or the second terminal 4₂, respectively form the first main conductor 2₁ and the second main conductor 22 in the second sub-section 5₂ of the connecting assembly 1. The contact arms of the first and second contact elements 9₁ and 9₂, which are situated in the differential spur conductor section 3 between the contact-connection region K₁₃ or K₂₃ and the first terminal 4₁ or the second terminal 4₂, respectively form the first spur conductor 3₁ and the second spur conductor 3₂ of the connecting assembly 1.

In the representation according to FIGS. 3A and 3B, in the first sub-section 5₁ and in the second sub-section 5₂ of the differential main conductor section 2, the contact arms of the three-arm contact elements 9₁ and 9₂ are respectively enclosed by a common magnetizable body 6.

For the embodiment of a shielded differential bus system, in the differential bus plug connector 8, a shielding and an outer conductor contact-connection are respectively configured at the plug-in connector interfaces.

For shielding the differential bus plug connector 8, two metallic outer conductor shells 10₁ and 10₂ are preferably provided, which are configured in a mutually connectable arrangement and thus enclose the first and second contact elements 9₁ and 9₂ over the full perimeter thereof. For the purposes of outer conductor contact-connection with an associated outer conductor mating contact element of a differential mating plug connector or with an outer conductor of a shielded differential line, outer conductor contact regions 11₁, 11₂ and 11₃ are respectively configured on the two metallic outer conductor shells 10₁ and 10₂ at the three plug-in connector interfaces.

For electrical insulation between the differential inner conductor contact-connection regions K, both mutually and vis-á-vis the outer conductor contact-connection regions 11, insulating elements 12₁, 12₂ and 12₃ are respectively arranged at the three plug-in connector interfaces.

The connecting assembly 1 or the differential bus plug connector 8 comprise a housing 13, preferably having two mutually attachable housing shells 13₁ and 13₂. The two outer conductor shells 11₁ and 11₂ are inserted and secured in the housing 13. In the two outer conductor shells 11₁ and 11₂, the connecting assembly 1 according to the invention, i.e. the first and the second contact element 9₁ and 9₂ of the differential bus plug connector 8 having the associated magnetizable bodies 6, is inserted and secured by means of the insulating elements 12₁, 12₂ and 12₃. For the contact-connection of the differential bus plug connector 8 with associated differential mating plug connectors, associated penetrations 14₁, 14₂, 14₃ are configured in the housing.

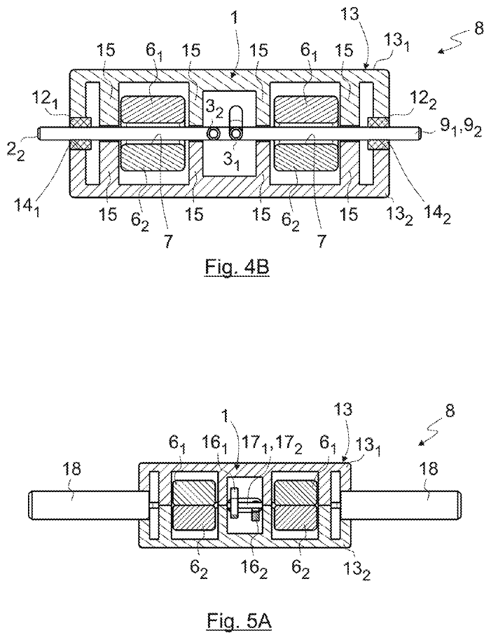

FIGS. 4A and 4B illustrate a further embodiment of a connecting assembly 1 for a differential bus system, which is embodied as a differential bus plug connector 8. The differential bus system, as per the differential bus plug connector 8 represented, is not executed with respective shielding, and thus comprises no metallic outer conductor shells 10₁ and 10₂.

The magnetizable bodies 6 are configured with a two-part construction, and respectively comprise a first magnetizable sub-body 6₁ and a second magnetizable sub-body 6₂. The magnetizable sub-bodies 6₁ and 6₂ are secured in an associated electrically insulating housing shell 13₁ or 13₂. An axial fixing of the two magnetizable sub-bodies 6₁ and 6₂ is executed by means of struts 15 which are respectively molded in the housing shells 13₁ and 13₂. A radial fixing is realized by a matching of the internal diameter of the penetrations 7 of the two magnetizable bodies 6 with the external diameter of the first and second contact elements 9₁ and 9₂. The struts 15 are additionally employed for guiding the first and second contact elements 9₁ and 9₂ within the differential bus plug connector 8.

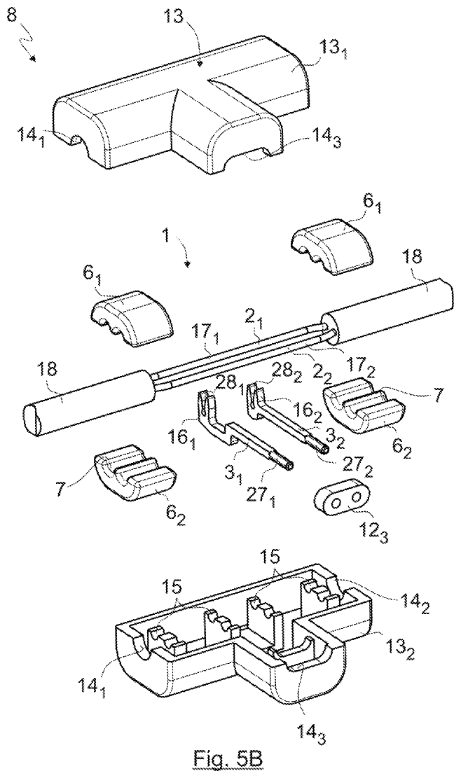

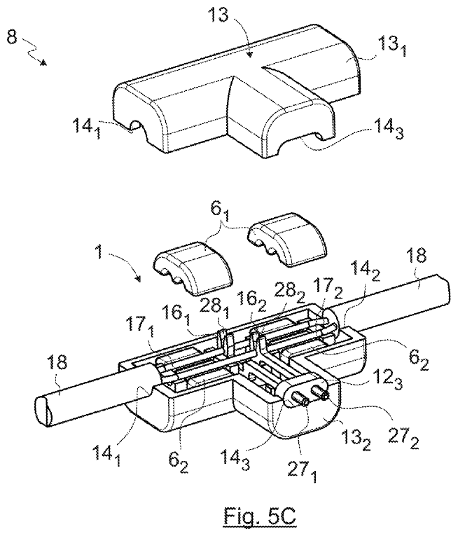

In a further embodiment of an unshielded connecting assembly 1 according to FIGS. 5A to 5C, contact connection between the first main conductor 2₁ and the first spur conductor 3₁, and between the second main conductor 2₂ and the second spur conductor 3₂, is executed by means of a first insulation-piercing connecting device 16₁ or a second insulation-piercing connecting device 16₂.

Litz wires of a first main line 17₁ and a second main line 17₂ form the first main conductor 2₁ or the second main conductor 2₂ of the connecting assembly 1. The first main line 17₁ and the second main line 17₂ are enclosed, for example, by a cable sheathing 18, and are released from the cable sheathing 18 in the region of the connecting assembly 1.

In this embodiment, a first contact terminal 27₁ or a second contact terminal 27₂, which are respectively integrally connected to the first insulation-piercing connecting device 16₁ and to the second insulation piercing connecting device 16₂, form the first spur conductor 3₁ or the second spur conductor 3₂. The first and second insulation-piercing connecting devices 16₁ and 16₂, at their first edge 28₁ or second edge 28₂, interrupt the insulation of the first or second main conductor section 17₁ and 17₂, such that an electrical contact is realized between the Litz wires of the first and second main conductor sections 17₁ and 17₂ and the first contact terminal 27₁ or the second contact terminal 27₂. The first and second contact terminals 27₁ and 27₂ form a differential and unshielded plug-in interface of a connecting assembly 1 which is embodied as a differential bus plug connector 8. At this differential plug-in connector interface, a mating plug connector which is configured on the differential input of the bus subscriber TN can be plugged in. Alternatively, the first and second contact terminals 27₁ and 27₂ can be respectively electrically connected to the Litz wires of a differential spur 3 which, in turn, for example by means of a plug-in connection, is electrically connectable to a bus subscriber TN.

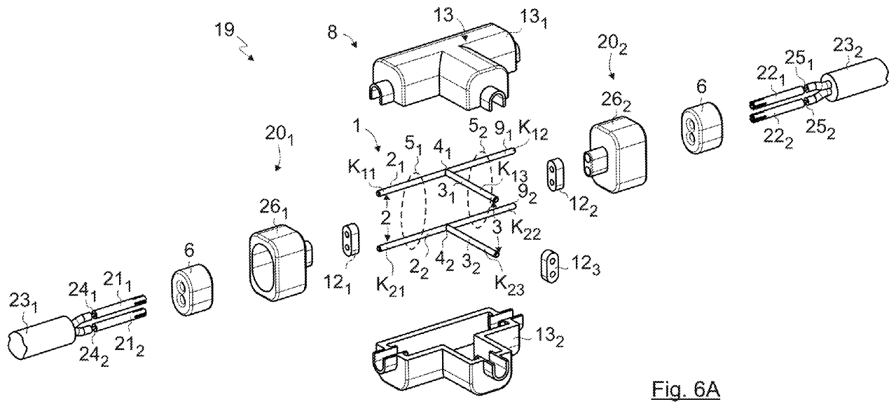

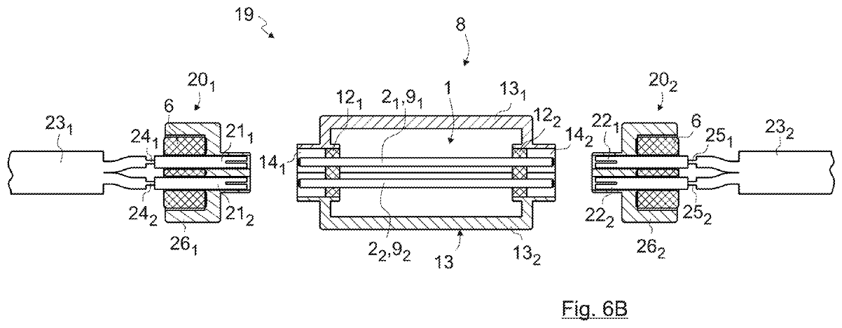

In a further embodiment of a connecting assembly 1 according to FIGS. 6A and 6B, a differential pug connector assembly 19 is provided, which is comprised of a differential bus plug connector 8 and, for example, three corresponding differential mating plug connectors 20. The magnetizable bodies 6 are not arranged within the differential bus plug connector 8, but in a first differential mating plug connector 20₁ and in a second differential mating plug connector 20₂. The first differential mating plug connector 20₁, in combination with the differential bus plug connector 8 in the first sub-section 5₁ of the differential main conductor section 2, forms an electrical plug-in connection. The second differential mating plug connector 20₂, in combination with the differential bus plug connector 8 in the second sub-section 5₁ of the differential main conductor section 2, form an electrical plug-in connection.

The two mating contact elements 21₁ and 21₂ of the first differential mating plug connector 20₁ and the two mating contact elements 22₁ and 22₂ of the second differential mating plug connector 20₂ are respectively enclosed by a magnetizable body 6. The two mating contact elements 21₁ and 21₂ of the first differential mating plug connector 20₁ are electrically connected to a first main conductor 24₁ or to a second main conductor 24₂ of a differential main line section 23₁ of the differential bus system, for example by means of a crimped connection. The two mating contact elements 22₁ and 22₂ of the second differential mating plug connector 20₂ are, for example, electrically connected in an equivalent manner to a first main conductor 25₁ or to a second main conductor 25₂ of a further differential main line section 23₂ of the differential bus system. The two mating contact elements 21₁ and 21₂ of the first differential mating plug connector 20₁ and the two mating contact elements 22₁ and 22₂ of the second differential mating plug connector 20₂ are respectively arranged, together with the associated magnetizable bodies 6, in a plug connector housing 26₁ and 26₂ of the first and second differential mating plug connectors 20₁ and 20₂, and are secured therein, for example, by means of adhesive bonding.

Although the present invention has been entirely described heretofore with reference to preferred exemplary embodiments, it is not limited thereto, but is modifiable in a variety of ways.

1. A connecting assembly for electrically connecting a bus subscriber to a differential bus system comprising:
a differential main conductor section having a first main electrical conductor and a second main electrical conductor,
wherein the differential main conductor section comprises a first sub-section and a second sub-section which is electrically connected to the first sub-section,
wherein, in the first main electrical conductor, between the first sub-section and the second sub-section, a first terminal for electrically connecting to a first mating terminal of the bus subscriber and, in the second main electrical conductor, between the first sub-section and the second sub-section, a second terminal for electrically connecting to a second mating terminal of the bus subscriber are configured,
wherein the connecting assembly further comprises a first electrical spur conductor and a second electrical spur conductor,
wherein the first electrical spur conductor is connected to the first terminal, and is designed to be connectable to the first mating terminal, and the second electrical spur conductor is connected to the second terminal, and is to be connectable to the second mating terminal, and
wherein only the first and the second main electrical conductor at least in one of the first sub-section and in the second sub-section, is respectively enclosed by a body of a magnetizable material.

2. The connecting assembly as claimed in claim 1,
wherein the body is configured as a bushing, and comprises a penetration for a feedthrough of (i) the first main electrical conductor, in the first sub-section, (ii) the second main electrical conductor, in the first sub-section, (iii) the first main electrical conductor, in the second sub-section, or (iv) the second main electrical conductor, in the second sub-section.

3. The connecting assembly as claimed in claim 1,
wherein the body along a longitudinal axis, comprises two penetrations for a feedthrough of (i) the first and second main electrical conductors, in the first sub-section, or (ii) the first and second main electrical conductors, in the second sub-section.

4. The connecting assembly as claimed in claim 1,
wherein the connecting assembly further comprises a housing in which the differential main conductor section is arranged, the housing comprising a penetration for the first sub-section, a penetration for the second sub-section, and a penetration for electrically connecting to at least one of the first mating terminal and the second mating terminal.

5. The connecting assembly as claimed in claim 1,
wherein the body includes a first sub-body and a second sub-body, each of which extends over a different angular segment relative to a longitudinal axis of the body.

6. The connecting assembly as claimed in claim 4,
wherein each of the first sub-body and the second sub-body is fixed in an associated housing part of the housing.

7. The connecting assembly as claimed in claim 1,
wherein the body is respectively configured (i) as a coating or (ii) as an encapsulation on the first main electrical conductor and on the second main electrical conductor.

8. The connecting assembly as claimed in claim 1,
wherein the first main electrical conductor is configured as an electrical conductor of a first main line section and the second main electrical conductor is configured as an electrical conductor of a second main line section,
wherein the connecting assembly further comprises a first insulation-piercing connecting device and a second insulation-piercing connecting device,
wherein the first insulation-piercing connecting device comprises a first edge, which electrically contact-connects the first terminal and a first contact terminal and
wherein the second insulation-piercing connecting device comprises a second edge, which electrically contact-connects the second terminal and a second contact terminal.

9. The connecting assembly as claimed in claim 8,
wherein the first main line section and the second main line section, are respectively enclosed by the body.

10. The connecting assembly as claimed in claim 1,
wherein the body is configured to increase an inductance in the main conductor section, such that a stray capacitance (C_{dev}) on a differential input of the bus subscriber is at least partially compensated by at least one of (i) a selection of an appropriate geometry for the body, and (ii) by a selection of an appropriate material for the body.

11. A differential electric bus plug connector for a differential bus system, comprising
a connecting assembly that includes a differential main conductor section having a first main electrical conductor and a second main electrical conductor, wherein the differential main conductor section comprises a first sub-section and a second sub-section which is electrically connected to the first sub-section,
wherein, in the first main electrical conductor, between the first sub-section and the second sub-section, a first terminal for electrically connecting to a first mating terminal of the bus subscriber and, in the second main electrical conductor, between the first sub-section and the second sub-section, a second terminal for electrically connecting to a second mating terminal of the bus subscriber are configured,
wherein the connecting assembly further comprises a first electrical spur conductor and a second electrical spur conductor,
wherein the first electrical spur conductor is connected to the first terminal, and is connectable to the first mating terminal, and the second electrical spur conductor is connected to the second terminal, and is connectable to the second mating terminal, and
wherein only the first and the second main electrical conductor, at least in one of the first sub-section and in the second sub-section, is respectively enclosed by a body of a magnetizable material,
wherein the first main electrical conductor is configured as a first contact element and the second main electrical conductor is configured as a second contact element.

12. A differential electric bus plug connector, for a differential bus system, comprising
a connecting assembly for electrically connecting a bus subscriber to the differential bus system,
the connecting assembly comprising a differential main conductor section including a first main electric conductor and a second main electric conductor, wherein the differential main conductor section further includes a first sub-section and a second sub-section which is electrically connected to the first sub-section,
wherein, in the first main electrical conductor, between the first sub-section and the second sub-section, a first terminal is configured for electrically connecting to a first mating terminal of the bus subscriber and, in the second main electrical conductor, between the first sub-section and the second sub-section, a second terminal is configured for electrically connecting to a second mating terminal of the bus subscriber
wherein each of the first terminal and the second terminal is respectively configured as a contact-connection region for a mating contact element of a mating plug connector of the bus subscriber,
wherein the first main electrical conductor and the second main electrical conductor, at least in the first sub-section or in the second sub-section are respectively enclosed by a body of a magnetizable material; and
wherein the first main electrical conductor is configured as a first contact element and the second main electrical conductor is configured as a second contact element.

13. The differential electric bus plug connector as claimed in claim 11,
wherein each of the first contact element and the second contact element, at least in one of the first sub-section and in the second sub-section, is respectively enclosed by the body.

14. A differential electric plug connector assembly, for a differential bus system, comprising:
a differential electric bus plug connector comprising a connecting assembly that includes a differential main conductor section having a first main electrical conductor and a second main electrical conductor, wherein the differential main conductor section comprises a first sub-section and a second sub-section which is electrically connected to the first sub-section,
wherein, in the first main electrical conductor, between the first sub-section and the second sub-section, a first terminal for electrically connecting to a first mating terminal of the bus subscriber and, in the second main electrical conductor, between the first sub-section and the second sub-section, a second terminal for electrically connecting to a second mating terminal of the bus subscriber are configured,
wherein the connecting assembly further comprises a first electrical spur conductor and a second electrical spur conductor,
wherein the first electrical spur conductor is connected to the first terminal, and is connectable to the first mating terminal, and the second electrical spur conductor is connected to the second terminal, and is connectable to the second mating terminal, and
wherein the first and second the main electrical conductors, at least in one of the first sub-section and in the second sub-section, is respectively enclosed by a body of a magnetizable material,
wherein the first main electrical conductor is configured as a first contact element and the second main electrical conductor is configured as a second contact element; and
a first differential electric mating plug connector and a second differential electric mating plug connector, each respectively having two mating contact elements,
wherein each of the two mating contact elements of the first differential mating plug connector electrically contact-connects the contact elements in the first sub-section, and each of the two mating contact elements of the second differential mating plug connector electrically contact-connects the contact elements in the second sub-section.

15. A differential electric plug connector assembly, for a differential bus system, comprising:
a differential electric plug connector having a connecting assembly for electrically connecting a bus subscriber to the differential bus system,
a first differential electric mating plug connector and a second differential electric mating plug connector,
wherein the connecting assembly of the bus plug connector comprises a differential main conductor section having a first main electrical conductor and a second main electrical conductor,
wherein the differential main conductor section comprises a first sub-section and a second sub-section which is electrically connected to the first sub-section,
wherein, in the first main electrical conductor, between the first sub-section and the second sub-section, a first terminal is configured for electrically connecting to a first mating terminal of the bus subscriber and,
wherein, in the second main electrical conductor, between the first sub-section and the second sub-section, a second terminal is configured for electrically connecting to a second mating terminal of the bus subscriber,
wherein each of the first differential mating plug connector and the second differential mating plug connector respectively comprises two mating contact elements, and
wherein each of the two mating contact elements of the first differential mating plug connector electrically contact-connects one of the main electrical conductors in the first sub-section, and each of the two mating contact elements of the second differential mating plug connector electrically contact-connects one of the main electrical conductors in the second sub-section, and
wherein the mating contact elements of at least one of the first differential mating plug connector and of the second differential mating plug connector are respectively enclosed by a body of a magnetizable material.

16. The connecting assembly as claimed in claim 2, wherein the connecting assembly further comprises a housing in which the differential main conductor section is arranged, the housing comprising a penetration for the first sub-section, a penetration for the second sub-section, and a penetration for electrically connecting to at least one of the first mating terminal and the second mating terminal.

17. The connecting assembly as claimed in claim 3, wherein the connecting assembly further comprises a housing in which the differential main conductor section is arranged, the housing comprising a penetration for the first sub-section, a penetration for the second sub-section, and a penetration for electrically connecting to at least one of the first mating terminal and the second mating terminal.

18. The connecting assembly as claimed in claim 2, wherein the body includes a first sub-body and a second sub-body, each of which extends over a different angular segment relative to a longitudinal axis of the body.

19. The connecting assembly as claimed in claim 3, wherein the body includes a first sub-body and a second sub-body, each of which extends over a different angular segment relative to a longitudinal axis of the body.

20. The connecting assembly as claimed in claim 4, wherein the body includes a first sub-body and a second sub-body, each of which extends over a different angular segment relative to a longitudinal axis of the body.
